(19) United States
(12) Patent Application Publication
(10) Pub. No.: US 2015/0319694 A1
(43) Pub. Date: Nov. 5, 2015

(54) WIRELESS COMMUNICATIONS APPARATUS AND WIRELESS COMMUNICATIONS METHOD USING THE SAME

(71) Applicant: SAMSUNG ELECTRO-MECHANICS CO., LTD., Suwon-si (KR)

(72) Inventor: Young Sik JEON, Suwon-Si (KR)

(73) Assignee: SAMSUNG ELECTRO-MECHANICS CO., LTD., Suwon-Si (KR)

(21) Appl. No.: 14/671,260

(22) Filed: Mar. 27, 2015

(30) Foreign Application Priority Data
Apr. 30, 2014 (KR) 10-2014-0052817
Nov. 3, 2014 (KR) 10-2014-0151015

(51) Int. Cl. H04W 52/02; H04W 4/02; H04W 48/16

(52) U.S. Cl. CPC H04W 52/0222; H04W 48/16; H04W 52/0235; H04W 4/025

(57) ABSTRACT

A wireless communications apparatus may include a wireless communications unit communicating with an access point; a first controlling unit detecting an accessible access point which is accessible through the wireless communications unit and controlling access between the detected access point and the wireless communications unit; a sensor unit including at least one sensor; and a second controlling unit receiving sensing information from the sensor unit, and determining whether or not a location of the wireless communications apparatus is changed, on the basis of the sensing information, wherein when the accessible access point is not detected, if the second controlling unit determines that the location of the wireless communications apparatus is changed, the first controlling unit re-detects an access point which is accessible through the wireless communications unit.

### CROSS-REFERENCE TO RELATED APPLICATIONS

This application claims priorities to, and the benefits of, Korean Patent Application No. 10-2014-0052817 filed on Apr. 30, 2014 and 10-2014-0151015 filed on Nov. 3, 2014, with the Korean Intellectual Property Office, the disclosures of which are incorporated herein by reference.

### BACKGROUND

The present disclosure relates to a wireless communications apparatus and a wireless communications method using the same.

In general, a mobile terminal may simultaneously have connectivity with various heterogeneous networks. For example, a mobile terminal in which high speed downlink packet access (HSDPA) and wireless Local Area Network (LAN) network interfaces are provided may detect an accessible wireless LAN access point (AP) in the vicinity of the mobile terminal in a state in which the wireless LAN network interface is consistently turned on, even in a situation in which a HSDPA network is used.

However, in this case, since the mobile terminal may perform the AP detection through scanning defined by the wireless LAN in order to consistently detect the wireless LAN AP, even in a situation in which the mobile terminal is not in the vicinity of the wireless LAN AP, an unnecessary waste of energy may be caused.

Specifically, according to the related art, when the mobile terminal detects an access point in the vicinity of the mobile terminal, the mobile terminal periodically continues detecting access points, in the case in which access is not made. Since such an operation is periodically performed until the mobile terminal accesses an access point, there may be a problem that an excessive amount of power may be consumed.

### SUMMARY

An exemplary embodiment in the present disclosure may provide a wireless communications apparatus capable of significantly reducing a detection of access points by determining a location change of the wireless communications apparatus on the basis of sensing information and allowing the wireless communications apparatus to detect wireless LAN access points only when the location change is present on the basis of the determination of the location change, and reducing power consumption for wireless LAN detection accordingly, and a wireless communications method using the same.

An exemplary embodiment in the present disclosure may also provide a wireless communications apparatus capable of reducing power consumption for wireless LAN detection by determining, by a second controlling unit, whether or not a location change of the wireless communications apparatus is present even when a first controlling unit is in a sleep mode and controlling a wireless communications unit to directly detect access points when the location change is present, and a wireless communications method using the same.

According to an exemplary embodiment in the present disclosure, a wireless communications apparatus may include: a wireless communications unit communicating with an access point; a first controlling unit detecting an accessible access point which is accessible through the wireless communications unit, and controlling access between the detected access point and the wireless communications unit; a sensor unit including at least one sensor; and a second controlling unit receiving sensing information from the sensor unit, and determining whether or not a location of the wireless communications apparatus is changed, on the basis of the sensing information, wherein when the accessible access point is not detected, if the second controlling unit determines that the location of the wireless communications apparatus is changed, the first controlling unit re-detects an access point which is accessible through the wireless communications unit.

When the accessible access point is not detected and the first controlling unit is in a sleep mode, if it is determined that the location of the wireless communications apparatus is changed, the second controlling unit may re-detect an access point which is accessible through the wireless communications unit and may control access between the detected access point and the wireless communications unit.

According to an exemplary embodiment in the present disclosure, a wireless communications apparatus may include: a wireless communications unit communicating with an access point; a first controlling unit detecting an accessible access point which is accessible through the wireless communications unit and controlling access between the detected access point and the wireless communications unit; a sensor unit including at least one sensor; and a second controlling unit receiving sensing information from the sensor unit, and determining whether or not a location of the wireless communications apparatus is changed, on the basis of the sensing information, wherein when the wireless communications unit accesses the access point, if the second controlling unit determines that the location of the wireless communications apparatus is changed, the first controlling unit re-detects an access point which is accessible through the wireless communications unit.

The first controlling unit may measure signal strength of the detected access point, and control the wireless communications unit to access the re-detected access point when signal strength of the re-detected access point is stronger than signal strength of a currently accessed access point.

According to an exemplary embodiment in the present disclosure, a wireless communications method using a wireless communications apparatus including a first controlling unit detecting an access point which is accessible through a wireless communications unit and controlling access between the detected access point and the wireless communications unit and a second controlling unit receiving a sensing signal from at least one sensor to determine whether or not a location of the wireless communications apparatus is changed, the wireless communications method may include: detecting, by the first controlling unit, an accessible access point which is accessible through the wireless communications unit around the wireless communications apparatus; sensing, by the second controlling unit, a location change of the wireless communications apparatus, if the accessible access point is not detected; and re-detecting, by the first controlling unit, an access point which is accessible through the wireless communications unit in a changed location of the wireless communications apparatus, if the location change is sensed.

The wireless communications method may further include: after the detecting of the accessible access point, if the accessible access point is not detected and the first controlling unit is in a sleep mode, sensing, by the second controlling unit, the location change of the wireless communications apparatus; and re-detecting, by the second controlling unit, an access point which is accessible through the wireless communications unit in a changed location of the wireless communications apparatus, if the location change is sensed.

The wireless communications method may further include: after the detecting of the access point, accessing, by the wireless communications unit, the accessible access point, if the accessible access point is detected; sensing, by the first controlling unit, the location change of the wireless communications apparatus; and re-detecting, by the first controlling unit, the access point in the changed location of the wireless communications apparatus, if the location change is sensed.

### BRIEF DESCRIPTION OF DRAWINGS

The above and other aspects, features and advantages in the present disclosure will be more clearly understood from the following detailed description taken in conjunction with the accompanying drawings, in which:

FIG. 1 is a configuration diagram illustrating a wireless communications apparatus according to an exemplary embodiment in the present disclosure;

FIG. 2 is a configuration diagram illustrating a wireless communications apparatus according to another exemplary embodiment in the present disclosure;

FIG. 3 is a configuration diagram illustrating an example of a second controlling unit of FIG. 2;

FIG. 4 is a flowchart illustrating a wireless communications method according to an exemplary embodiment in the present disclosure;

FIG. 5 is a flowchart illustrating a wireless communications method according to another exemplary embodiment in the present disclosure; and

FIG. 6 is a flowchart illustrating a wireless communications method according to another exemplary embodiment in the present disclosure.

### DETAILED DESCRIPTION

Exemplary embodiments in the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

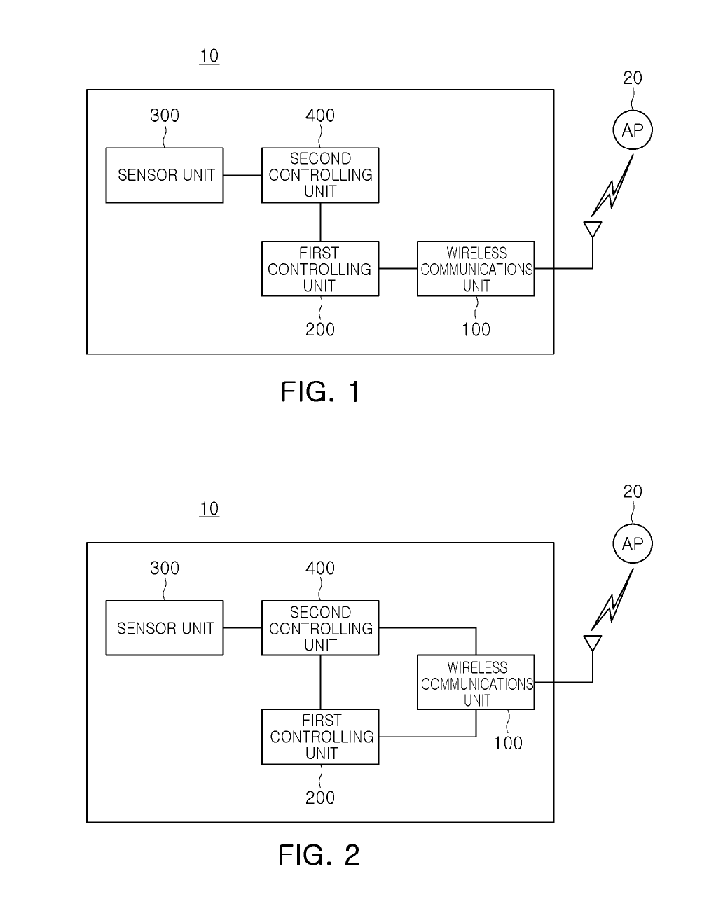

FIG. 1 is a configuration diagram illustrating a wireless communications apparatus according to an exemplary embodiment in the present disclosure.

Referring to FIG. 1, a wireless communications apparatus 10 according to an exemplary embodiment in the present disclosure may include a wireless communications unit 100, a first controlling unit 200, a sensor unit 300, and a second controlling unit 400.

The wireless communications unit 100 may perform communications with an access point (AP) 20 according to a control of the first controlling unit 200 and may be communicatively connected to the access point 20 or communicatively disconnected from the access point 20.

The first controlling unit 200 may control an overall operation of the wireless communications apparatus 10, detect an access point 20 which is accessible through the wireless communications unit 100 around the wireless communications apparatus 10, and control access between the detected access point 20 and the wireless communications unit 100 if the accessible access point 20 is detected.

In addition, if the accessible access point 20 is not detected, the first controlling unit 200 may detect the accessible access point 20 at a predetermined period in order to perform wireless communications. However, if a location of the wireless communications apparatus 10 is not changed, the first controlling unit 200 may not detect the accessible access point 20 even though a re-detection is performed as long as a new access point is not generated.

In this case, the first controlling unit 200 may periodically perform a detecting operation until the access to the access point 20 is made even in a situation in which the access point 20 is not present around the wireless communications apparatus 10, thereby causing a problem that a lot of power is consumed.

In order to solve the problem described above, the first controlling unit 200 may re-detect the accessible access point 20 in the changed location of the wireless communications apparatus 10 if the location of the wireless communications apparatus 10 is changed.

That is, even in the case in which the first controlling unit 200 does not find the accessible access point 20, if the location of the wireless communications apparatus 10 is not changed, the first controlling unit 200 may not perform the re-detection of the access point 20, but may perform the re-detection of the accessible access point 20 in the case in which the location of the wireless communications apparatus 10 is changed.

Specifically, the second controlling unit 400 may determine that the location of the wireless communications apparatus 10 is changed, on the basis of sensing information received from the sensor unit 300, and if the first controlling unit 200 receives a signal informing that the location of the wireless communications apparatus 10 is changed, from the second controlling unit 400, the first controlling unit 200 may re-detect the access point 20 which is accessible through the wireless communications unit 100.

Here, if the first controlling unit 200 is not operated for a predetermined time, the first controlling unit 200 may be switched into a sleep mode. In this case, in the case in which it is determined that the location of the wireless communications apparatus 10 is changed on the basis of the sensing information received from the sensor unit 300, the second controlling unit 400 may output a wake-up signal including a signal informing the location change to the first controlling unit 200. If the first controlling unit 200 receives the wake-up signal, the first controlling unit 200 may re-detect the access point 20 around the wireless communications apparatus 10 through the wireless communications unit 100 and may control access between the access point 20 and the wireless communications unit 100.

According to another exemplary embodiment, the first controlling unit 200 may roam a voice or data signal of the wireless communications apparatus depending on signal strength of the access point.

That is, if it is determined that the roaming is required, the first controlling unit 200 may perform the roaming so as to detect a peripheral signal, generate list information depending on strength of the detected signal, perform wireless communications using a currently accessed access point if the detected signal has strength weaker than that of a signal of a pre-accessed access point, and perform wireless communications through the detected signal if the detected signal has strength stronger than that of the signal of the pre-accessed access point.

Specifically, even in the case in which the wireless communications unit 100 currently accesses the access point, if it is determined that the location of the wireless communications apparatus 10 is changed, the first controlling unit 200 may perform the re-detection of the access point in the changed location, and the first controlling unit 200 may measure signal strength of the re-detected access point so as to compare it with signal strength of the currently accessed access point and may control the wireless communications unit 100 so as to access the re-detected access point if the signal strength of the re-detected access point is stronger than the signal strength of the currently accessed access point as the comparison result.

Here, when the first controlling unit 200 is switched into the sleep mode, in the case in which it is determined that the location of the wireless communications apparatus 10 is changed on the basis of the sensing information received from the sensor unit 300, the second controlling unit 400 may output the wake-up signal including the signal informing the location change to the first controlling unit 200.

If the first controlling unit 200 receives the wake-up signal, the first controlling unit 200 may re-detect the access point 20 around the wireless communications apparatus 10 through the wireless communications unit 100, measure signal strength of the re-detected access point so as to compare it with signal strength of the currently accessed access point, and control the wireless communications unit 100 so as to access the re-detected access point if the signal strength of the re-detected access point is stronger than the signal strength of the currently accessed access point as the comparison result.

According to an exemplary embodiment, the first controlling unit 200 may include a processing unit and a memory. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

The sensor unit 300 may include at least one sensor, sense a state of the wireless communications apparatus 10, and generate sensing information depending on a state change of the wireless communications apparatus 10 so as to transmit the sensing information to the second controlling unit 400.

According to an exemplary embodiment, the sensor unit 300 may include at least one of an accelerator sensor, a gyroscope sensor, an infrared sensor, a magnetic sensor, a position sensor, and a gesture sensor recognizing a gesture of a user.

In addition, the sensor unit 300 may further include at least one of a proximity sensor, an illumination sensor, a temperature-humidity sensor, an atmospheric pressure sensor, a hall sensor, and a heartbeat sensor, in addition to the sensors mentioned above.

The second controlling unit 400 may control the sensor unit 300 and receive the sensing information from the sensor unit 300. In addition, the second controlling unit 400 may determine whether or not the location of the wireless communications apparatus 10 is changed, on the basis of the sensing information.

Here, the second controlling unit 400 may receive a measurement value from at least one sensor included in the sensor unit 300 and may calculate a location change value using the received measurement value.

Here, the second controlling unit 400 may calculate the location change value using the measurement value received from one sensor and may calculate the location change value by combining measurement values received from a plurality of sensors.

The second controlling unit 400 may compare the calculated location change value with a preset reference value (e.g., 1 m). If the location change value is larger than the reference value, the second controlling unit 400 may determine that the location of the wireless communications apparatus 10 is changed and may output a signal informing that the location of the wireless communications apparatus 10 is changed, to the first controlling unit 200.

According to an exemplary embodiment, the second controlling unit 400 may be driven by a control of the first controlling unit 200. In addition, even in the case in which the first controlling unit is in the state of the sleep mode, the second controlling unit 400 may be driven in a wake-up state. By controlling the sensor unit 300 by the second controlling unit 400, the sensor unit 300 may be controlled irrespective of a load of the first controlling unit 200.

In addition, the second controlling unit 400 may be designed so as to be driven at low power. Therefore, even in the case in which the first controlling unit 200 is in the sleep state, the sensor unit 300 may be controlled at low power by driving the second controlling unit 400. In addition, the second controlling unit 400 may separately control one or more sensors included in the sensor unit 300.

According to an exemplary embodiment, the second controlling unit 400 may include a processing unit and a memory. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

In addition, the second controlling unit 400 may be included as a component in a portion of the first controlling unit 200 depending on an exemplary embodiment. More specifically, the first controlling unit 200 and the second controlling unit 400 may be configured as one-chip processor, and the first controlling unit 200 may include the second controlling unit 400, and more particularly, the second controlling unit 400 may be disposed as a partial component of the first controlling unit 200.

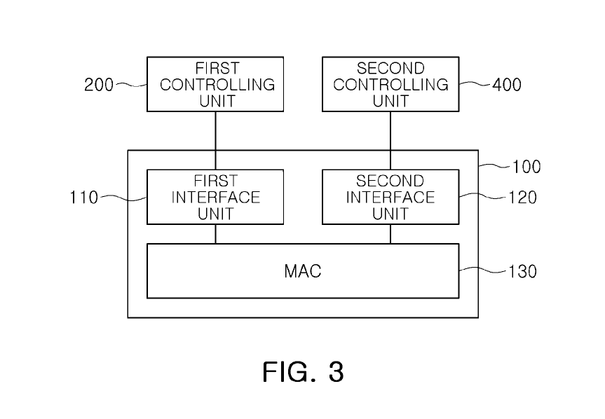

FIG. 2 is a configuration diagram illustrating a wireless communications apparatus according to another exemplary embodiment in the present disclosure and FIG. 3 is a configuration diagram illustrating one example of a second controlling unit of FIG. 2.

An exemplary embodiment of FIG. 2 has the same basic configuration as that of an exemplary embodiment of FIG. 1. However, a difference is that because the wireless communications unit 100 is connected to the second controlling unit 400, the second controlling unit 400 may re-detect the access point 20 around the wireless communications apparatus 10 through the wireless communications unit 100 and control the access between the detected access point and the wireless communications unit 100 if the location of the wireless communications apparatus 10 is changed when the first controlling unit 200 is in the sleep mode.

According to an exemplary embodiment, even in the case in which the accessible access point is detected and the wireless communications apparatus 10 accesses the accessible access point, if it is determined that the location of the wireless communications apparatus 10 is changed, the second controlling unit 400 may perform the re-detection of the access point in the changed location.

This is to perform the roaming of the access point. According to an exemplary embodiment, the second controlling unit 400 may measure signal strength of the re-detected access point so as to compare it with signal strength of the currently accessed access point and may control the wireless communications unit 100 so as to access the re-detected access point if the signal strength of the re-detected access point is stronger than the signal strength of the currently accessed access point as the comparison result.

Referring to FIG. 3, the wireless communications unit 100 according to an exemplary embodiment may include a first interface 110 for transmitting and receiving data to and from the first controlling unit 200, a second interface 120 for transmitting and receiving data to and from the second controlling unit 400, a media access controller (MAC) 130.

Here, the first interface 110 may be SDIO 3.0 or PCIe which is a high speed data line, and the second interface 120 may be universal asynchronous receiver transmitter (UART) or I2C.

The MAC 130 may perform functions such as authentication, authorization, accounting for data communications between the first controlling unit 200 or the second controlling unit 400 and the access point 20 which are connected to each other through the first interface 110 or the second interface 120.

As such, by directly connecting the second controlling unit 400 to the wireless communications unit 100 through the second interface 120, even in the case in which the first controlling unit 200 is in the sleep mode, if the location of the wireless communications apparatus 10 is changed, the second controlling unit 400 may directly perform a control so as to detect the access point 20 around the wireless communications apparatus 10 through the wireless communications unit 100 and access the access point 20.

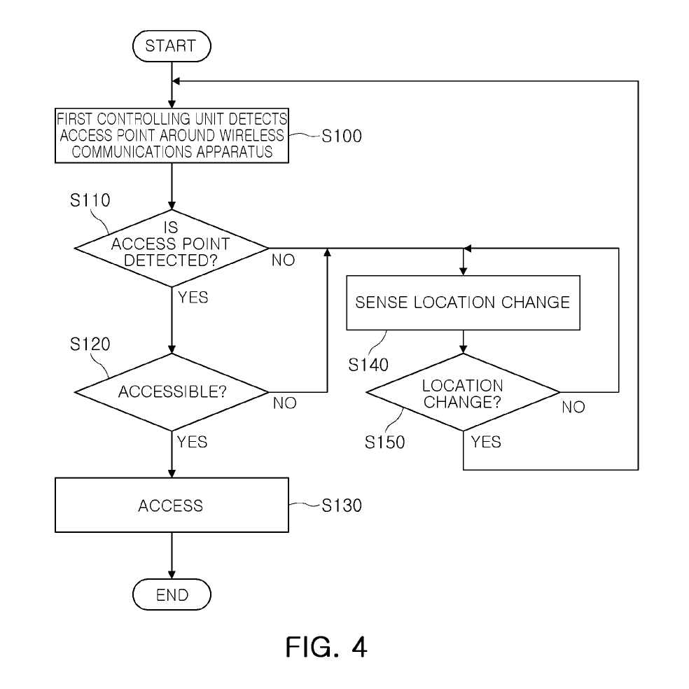

Hereinafter, a wireless communications method according to an exemplary embodiment in the present disclosure will be described with reference to FIGS. 4 through 7. However, since the wireless communications method described below is performed by the wireless communications apparatus described above with reference to FIGS. 1 through 3, a description of contents that are the same as or correspond to the above-mentioned contents will be omitted in order to avoid an overlapped description.

FIG. 4 is a flowchart illustrating a wireless communications method according to an exemplary embodiment in the present disclosure.

Referring to FIG. 4, first, the first controlling unit 200 may detect the access point 20 around the wireless communications apparatus 10 through the wireless communications unit 100 (S100). Here, if the accessible access point 20 is detected (S110, S120), the first controlling unit 200 may access the access point 20 through the wireless communications unit 100.

If the access point 20 is not detected (S110), or the access point 20 is not accessible even in the case in which the access point 20 is detected (S120), the second controlling unit 400 may sense a location change of the wireless communications apparatus 10 (S140). Here, if the location change is sensed (S150), the first controlling unit 200 may re-detect the access point which is accessible through the wireless communications unit 100 in the changed location of the wireless communications apparatus 10 (S100).

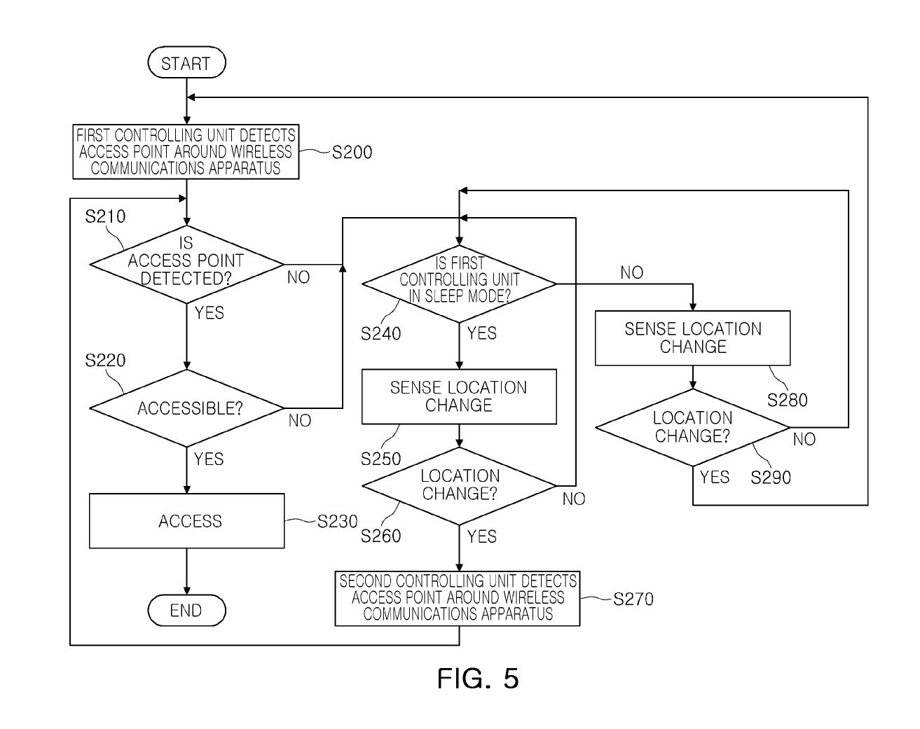

FIG. 5 is a flowchart illustrating a wireless communications method according to another exemplary embodiment in the present disclosure.

Referring to FIG. 5, the operation (S100) of detecting the access point 20 to the operation (S130) of accessing the access point 20 in the wireless communications method according to another exemplary embodiment in the present disclosure are the same as those in the wireless communications method according to an exemplary embodiment in the present disclosure, but if the access point 20 is not detected (S210), or the access point 20 is not accessible (S220) even in the case in which the access point 20 is detected and the first controlling unit 200 is not in the sleep mode (S240), the second controlling unit 400 may sense the location change of the wireless communications apparatus 10 (S280) similar to FIG. 4, and if the location change is sensed (S290), the first controlling unit 200 may detect the access point which is accessible through the wireless communications unit 100 in the changed location of the wireless communications apparatus 10 (S200).

Here, if the first controlling unit 200 is in the sleep mode (S240), the second controlling unit 400 may sense the location change of the wireless communications apparatus 10 (S250), and if the location change is sensed (S260), the second controlling unit 400 may re-detect the access point which is accessible through the wireless communications unit 100 in the changed location (S270).

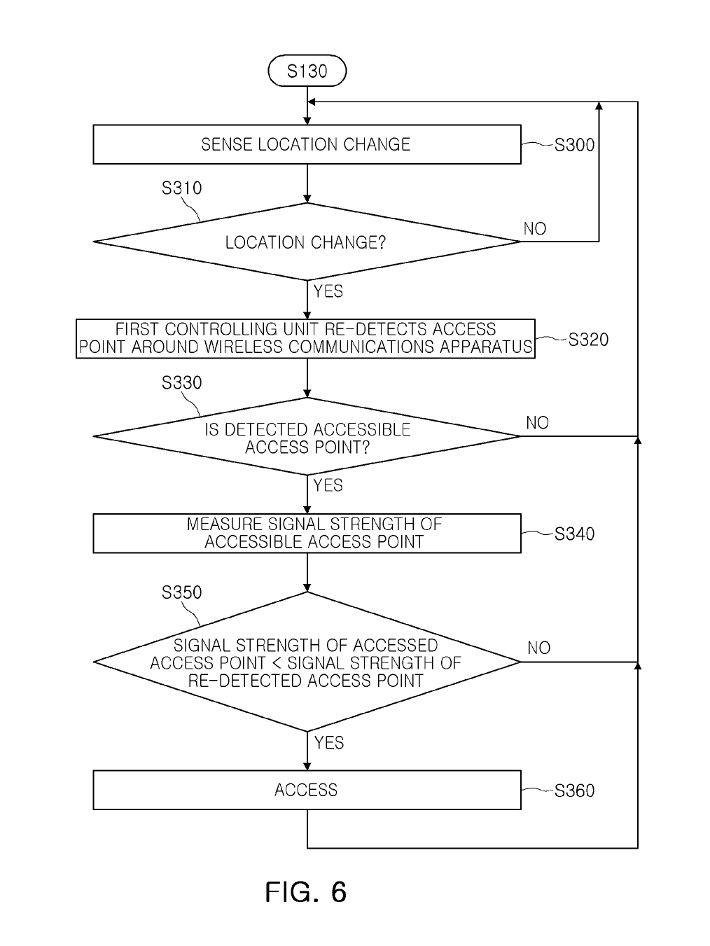

FIG. 6 is a flowchart illustrating a wireless communications method according to another exemplary embodiment in the present disclosure.

Referring to FIG. 6, after the wireless communications unit 100 accesses the access point, the second controlling unit 400 may sense a location change of the wireless communications apparatus 10 (S300), and if the location change is sensed by the second controlling unit 400 (S310), the first controlling unit 200 may re-detect the access point around the changed location (S320).

Here, if the accessible access point is detected (S330), the first controlling unit 200 may measure signal strength of the re-detected access point (S340), and if the signal strength of the re-detected access point is stronger than signal strength of a currently accessed access point (S350), the first controlling unit 200 may control the wireless communications unit 100 so as to access the re-detected access point (S360).

As set forth above, according to exemplary embodiments in the present disclosure, the location change of the wireless communications apparatus is determined on the basis of the sensing information and the wireless communications apparatus detects the wireless LAN access points only in the case in which the location change is present, on the basis of the determined location change, whereby the access point detection may be significantly reduced and the power consumption for the wireless LAN detection may be reduced accordingly.

In addition, the power consumption for the wireless LAN detection may be reduced by determining, by the second controlling unit, whether or not the location change of the wireless communications apparatus is present even in the case in which the first controlling unit is in a sleep mode and controlling the wireless communications unit so as to directly detect the access points in the case in which the location change is present.

While exemplary embodiments have been shown and described above, it will be apparent to those skilled in the art that modifications and variations could be made without departing from the scope of the present invention as defined by the appended claims.

What is claimed is:

1. A wireless communications apparatus comprising:
a wireless communications unit configured to communicate with an access point;
a first controlling unit configured to detect an accessible access point which is accessible through the wireless communications unit, and control access between the detected access point and the wireless communications unit;
a sensor unit configured to include at least one sensor; and
a second controlling unit configured to receive sensing information from the sensor unit, and determine whether or not a location of the wireless communications apparatus is changed, on the basis of the sensing information,
wherein when the accessible access point is not detected, if the second controlling unit determines that the location of the wireless communications apparatus is changed, the first controlling unit re-detects an access point which is accessible through the wireless communications unit.

2. The wireless communications apparatus of claim 1, wherein when the accessible access point is not detected and the first controlling unit is in a sleep mode, if it is determined that the location of the wireless communications apparatus is changed, the second controlling unit re-detects an access point which is accessible through the wireless communications unit, and controls access between the detected access point and the wireless communications unit.

3. The wireless communications apparatus of claim 1, wherein when the accessible access point is not detected and the first controlling unit is in a sleep mode, if it is determined that the location of the wireless communications apparatus is changed on the basis of the sensing information, the second controlling unit outputs a wake-up signal to the first controlling unit.

4. The wireless communications apparatus of claim 3, wherein if the first controlling unit receives the wake-up signal, the first controlling unit re-detects the access point which is accessible through the wireless communications unit, and controls the access between the detected access point and the wireless communications unit.

5. The wireless communications apparatus of claim 1, wherein the sensor unit includes at least one of an acceleration sensor, a gyroscope sensor, a geomagnetic sensor, and a position sensor.

6. The wireless communications apparatus of claim 1, wherein the second controlling unit determines that the location of the wireless communications apparatus is changed when a location change value of the wireless communications apparatus is equal to or greater than a reference value.

7. A wireless communications apparatus comprising:
a wireless communications unit configured to communicate with an access point;
a first controlling unit configured to detect an accessible access point which is accessible through the wireless communications unit, and control access between the detected access point and the wireless communications unit;
a sensor unit configured to include at least one sensor; and
a second controlling unit configured to receive sensing information from the sensor unit, and determine whether or not a location of the wireless communications apparatus is changed, on the basis of the sensing information,
wherein when the wireless communications unit accesses the access point, if the second controlling unit determines that the location of the wireless communications apparatus is changed, the first controlling unit re-detects an access point which is accessible through the wireless communications unit.

8. The wireless communications apparatus of claim 7, wherein the first controlling unit measures signal strength of the detected access point, and controls the wireless communications unit to access the re-detected access point when signal strength of the re-detected access point is stronger than signal strength of a currently accessed access point.

9. The wireless communications apparatus of claim 7, wherein when the first controlling unit is in a sleep mode, if it is determined that the location of the wireless communications apparatus is changed, the second controlling unit re-detects an access point which is accessible through the wireless communications unit, and controls access between the detected access point and the wireless communications unit.

10. The wireless communications apparatus of claim 9, wherein the second controlling unit measures signal strength of the detected access point, and controls the wireless communications unit to access the re-detected access point when signal strength of the re-detected access point is stronger than signal strength of a currently accessed access point.

11. The wireless communications apparatus of claim 7, wherein when the first controlling unit is in a sleep mode, if it is determined that the location of the wireless communications apparatus is changed on the basis of the sensing information, the second controlling unit outputs a wake-up signal to the first controlling unit.

12. The wireless communications apparatus of claim 11, wherein if the first controlling unit receives the wake-up signal, the first controlling unit re-detects the access point which is accessible through the wireless communications unit, and controls the access between the detected access point and the wireless communications unit.

13. The wireless communications apparatus of claim 12, wherein the first controlling unit measures signal strength of the detected access point, and controls the wireless communications unit to access the re-detected access point when signal strength of the re-detected access point is stronger than signal strength of a currently accessed access point.

14. The wireless communications apparatus of claim 7, wherein the sensor unit includes at least one of an acceleration sensor, a gyroscope sensor, a geomagnetic sensor, and a position sensor.

15. The wireless communications apparatus of claim 7, wherein the second controlling unit determines that the location of the wireless communications apparatus is changed when a location change value of the wireless communications apparatus is equal to or greater than a reference value.

16. A wireless communications method using a wireless communications apparatus including a first controlling unit detecting an access point which is accessible through a wireless communications unit and controlling access between the detected access point and the wireless communications unit and a second controlling unit receiving a sensing signal from at least one sensor to determine whether or not a location of the wireless communications apparatus is changed, the wireless communications method comprising:
detecting, by the first controlling unit, an accessible access point which is accessible through the wireless communications unit around the wireless communications apparatus;
sensing, by the second controlling unit, a location change of the wireless communications apparatus, if the accessible access point is not detected; and
re-detecting, by the first controlling unit, an access point which is accessible through the wireless communications unit in a changed location of the wireless communications apparatus, if the location change is sensed.

17. The wireless communications method of claim 16, further comprising: after the detecting of the accessible access point, if the accessible access point is not detected and the first controlling unit is in a sleep mode,
sensing, by the second controlling unit, the location change of the wireless communications apparatus; and
re-detecting, by the second controlling unit, an access point which is accessible through the wireless communications unit in a changed location of the wireless communications apparatus, if the location change is sensed.

18. The wireless communications method of claim 16, wherein in the sensing of the location change, if a location change value of the wireless communications apparatus is equal to or greater than a reference value, it is determined that the location of the wireless communications apparatus is changed.

19. The wireless communications method of claim 16, further comprising: after the detecting of the access point,
accessing, by the wireless communications unit, the accessible access point, if the accessible access point is detected;
sensing, by the first controlling unit, the location change of the wireless communications apparatus; and
re-detecting, by the first controlling unit, the access point in the changed location of the wireless communications apparatus, if the location change is sensed.

20. The wireless communications method of claim 19, further comprising: after the re-detecting of the access point,
measuring, by the first controlling unit, signal strength of the re-detected access point;
comparing, by the first controlling unit, the signal strength of the re-detected access point with signal strength of the accessed access point; and
accessing, by the wireless communications unit, the re-detected access point, if the signal strength of the re-detected access point is stronger than the signal strength of the accessed access point.
